(19) United States
(12) Patent Application Publication
(10) Pub. No.: US 2004/0081595 A1
(43) Pub. Date: Apr. 29, 2004

(54) Exhaust emission control devices and method of making the same

(76) Inventors: Alan G. Turek, Mayville, MI (US); John C. Boehnke, Grandblanc, MI (US)

Correspondence Address: Vincent A. Cichosz, Delphi Technologies, Inc., M/C 480-410-202, P.O. Box 5052, Troy, MI, 48007, US

(21) Appl. No.: 10/284,013

(22) Filed: Oct. 29, 2002

(51) Int. Cl. B01D 53/34

(52) U.S. Cl. 422/179; 422/177

(57) ABSTRACT

Exhaust emission control devices utilizing pelletized retention material and methods of making the same are disclosed herein. In one embodiment, the method comprises: disposing a treatment element within a shell, dispensing a pelletized retention material between the shell and the treatment element, and securing the retention material between the shell and the treatment element.

### BACKGROUND OF THE DISCLOSURE

Pollution or exhaust emission control devices are employed on motor vehicles to control atmospheric pollution. Two types of devices are currently in widespread use catalytic converters and diesel particulate filters or traps. Both types of devices contain a treatment element to control pollution. The treatment element in a catalytic converter is typically a catalytic element, a substrate or a monolithic structure coated with a catalyst and mounted in a housing. The monolithic structures are typically ceramic, although metal monoliths and foils have been used. The catalyst oxidizes carbon monoxide and hydrocarbons, and reduces the oxides of nitrogen in automobile exhaust gases to control atmospheric pollution. The treatment element in a diesel particulate filter or trap is often a wall flow filter having a honeycombed monolithic structure and typically made from porous crystalline ceramic materials.

Usually exhaust emission control devices have a metal housing that holds within it the treatment element. The treatment element generally has very thin walls to provide a large amount of surface area and is often fragile and susceptible to breakage. To avoid damage from road shock and vibration, to compensate for thermal expansion differences, and to prevent exhaust gases from passing between the treatment element and metal housing rather than through the treatment element itself, a retention mat is typically disposed between the treatment element and the metal housing to form a retention the treatment element subassembly.

The retention the treatment element subassembly is then inserted into the shell or housing under pressure using methods such as the “stuffing”method and the “tourniquet” method. Both wrapping the retention mat around the treatment element and stuffing the retention the treatment element subassembly into the shell cause pressure to be imposed on the treatment element. In the case of fragile treatment elements, such pressure has the potential to result in breakage of the treatment element. There thus remains a need for improved methods of making exhaust emission control devices.

### SUMMARY

Exhaust emission control devices utilizing pelletized retention material and methods of making the same are disclosed herein. In one embodiment, the method comprises: disposing a treatment element within a shell, dispensing a pelletized retention material between the shell and the treatment element, and securing the retention material between the shell and the treatment element.

In one embodiment, the exhaust emission control device comprises: a shell, a treatment element disposed within the shell, and a pelletized retention material disposed between the treatment element and the shell.

The above discussed and other features and advantages will be appreciated and understood by those skilled in the art from the following detailed description and drawings.

### BRIEF DESCRIPTION OF THE DRAWINGS

The following drawings are meant to be exemplary and not limiting.

FIG. 1 is a cross sectional view of an embodiment of an exhaust emission control device with one finished and one unfinished end.

FIG. 2 is a cross-sectional view of an embodiment of an exhaust emission control device with end cones at both ends.

FIG. 3 is a cross sectional view of an alternative embodiment of an exhaust emission control device with one finished and one unfinished end.

FIG. 4 is a cross sectional view of an alternative embodiment of an exhaust emission control device with end cones at both ends.

FIG. 5 is a cross sectional view of an alternative embodiment of an exhaust emission control device with double end cones at both ends.

### DETAILED DESCRIPTION

Exhaust emission control devices may comprise catalytic converters, evaporative emissions devices, scrubbing devices (e.g., those designed to remove hydrocarbon, sulfur, and the like), particulate filters/traps, adsorbers/absorbers, non-thermal plasma reactors, and the like, as well as combinations comprising at least one of the foregoing devices.

A typical exhaust emission control device includes an outer metallic housing or shell, a treatment element, and a retention element. The treatment element converts, and/or eliminates one or more emissions from an exhaust gas. The retention element at least partially fills the space between the treatment element and the shell.

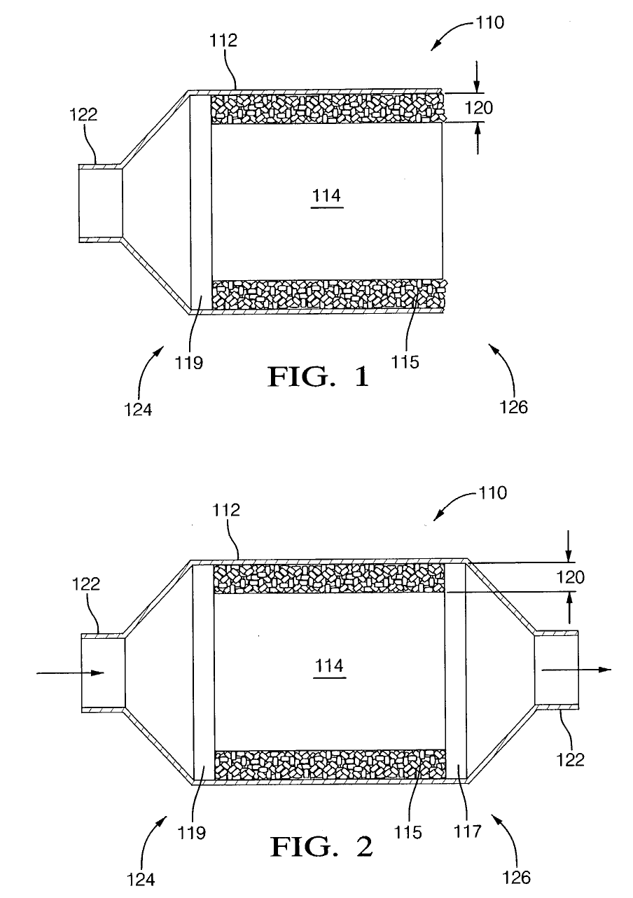

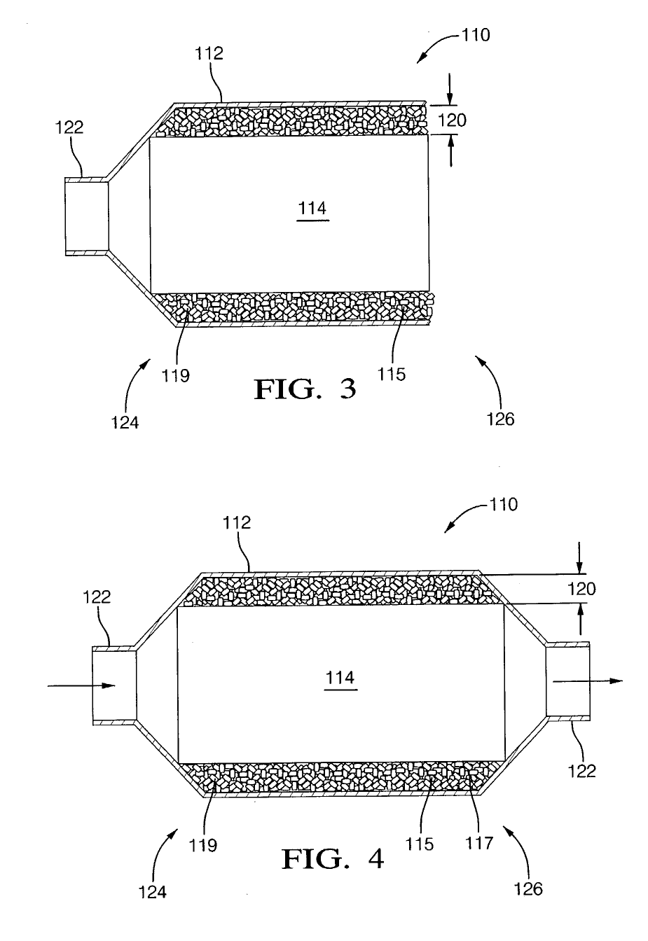

Referring to FIGS. 1 and 2, an exhaust emission control device 110 is conveniently formed from a shell 112, having an end cone, end plate or manifold (hereafter end cone 122) at a first end 124 of the device. The treatment element is preferably concentrically disposed within the shell 112 providing a space 120 between the treatment element 114 and the shell 112. A pelletized retention material is then poured, flowed, placed, dispensed or otherwise disposed into the space 120 between the treatment element 114 and the shell 112 to form the support element 115. An optional barrier 119, e.g., a wire rope, may be provided at the first end 124 to retain the pelletized retention material between the treatment element 114 and the shell 112. Alternatively, as shown in FIG. 3, the treatment element 114 may be optionally disposed in the shell 112 such that the space 120 at one end diminishes sufficiently to prevent passage of the pelletized retention material past the treatment element 114. After the pelletized retention material is disposed in the space 120, it is then secured in the space 120. In one embodiment shown in FIG. 4, spinforming or otherwise assembling an end cone 122 at the second end 126 secures the pelletized retention material. As shown in FIG. 2, another method of securing the pelletized mat support is to provide a second barrier 117, e.g., a wire rope, at the open end of the shell before assembling an end cone 122 on the second end 126.

The shell or housing 112 typically includes an end cone, plate or manifold 122 (hereinafter “end cone”) at a first end 124 and at second end 126 of exhaust emission control device 110. End cones are adapted to be connected to an exhaust pipe (not shown) of a vehicle. Accordingly, the end cones can be fluidly connected to the exhaust pipe so that the exhaust gas flows through the exhaust emission control device 110 and therefore, through the treatment element 114.

The choice of material for the shell or housing 112 and end cones 122 depends upon the type of exhaust gas, the maximum temperature reached by the exhaust emission control device 110, the maximum temperature of the exhaust gas stream, and the like. Suitable materials include materials capable of resisting under-car salt, temperature, and corrosion. Typically, ferrous materials are employed, e.g. ferritic stainless steels. Ferritic stainless steels include stainless steels such as, e.g., the 400 Series such as SS-409, SS-439, and SS-441.

The end cone assemblies 122, at the first end 124 and second end 126 can alternatively, individually, be end cones, end plates, manifolds, and combinations of the foregoing assemblies. These assemblies can be disposed on or formed by, for example, welding or other techniques in which a separate end cone is attached to end 124 or 126 of the shell 112, or by spinforming techniques in which an end cone is formed in a one piece unit with the shell. Alternatively, a double end-cone arrangement may be used in which an inner end cone 123 is attached within an outer end cone 125 and then the entire assembly welded onto the opening of a shell. The inner end cone 123 reduces the likelihood of thermal deterioration of the support element during operation of the exhaust emission control device. In the case of a double end-cone, the inner end cone 123 can be fitted around and end of the treatment element 114 prior to disposing the treatment element 114 in the shell 112. Preferably, the inner end cone can have an inner diameter greater than an outer diameter of the treatment element 114, wherein the difference between these diameters is preferably less than or equal to the minor axis diameter of the pelletized retention material.

The treatment element 114 comprises material designed for use in a spark ignition or diesel engine environment and having the following characteristics: (1) capable of operating at temperatures up to about 600° C., and up to about or even greater than about 1,000° C. for some applications, depending upon the device's location within the exhaust system (manifold mounted, close coupled, or underfloor) and the type of system (e.g., gasoline or diesel); (2) capable of withstanding exposure to hydrocarbons, nitrogen oxides, carbon monoxide, particulate matter (e.g., soot and the like), carbon dioxide, and/or sulfur; and (3) having sufficient surface area and structural integrity to support a catalyst, if desired. Some possible materials include cordierite, silicon carbide, metal, metal oxides (e.g., alumina, and the like), glasses, and the like, and mixtures comprising at least one of the foregoing materials. Some ceramic materials include “Honey Ceram”, commercially available from NGK-Locke, Inc, Southfield, Mich., and “Celcor”, commercially available from Corning, Inc., Corning, N.Y. These materials can be in the form of foils, preforms, mats, fibrous materials, monoliths (e.g., a honeycomb structure, and the like), other porous structures (e.g., porous glasses, sponges), foams, pellets, particles, molecular sieves, and the like (depending upon the particular device), and combinations comprising at least one of the foregoing materials and forms, e.g., metallic foils, open pore alumina sponges, and porous ultra-low expansion glasses.

Although the treatment element 114 can have any size or geometry, the size and geometry are preferably chosen to optimize the surface area for the given converter design parameters. Typically, the substrate has a honeycomb geometry, with the comb's through-channel having any multi-sided or rounded shape, with substantially square, triangular, pentagonal, hexagonal, heptagonal, or octagonal or similar geometries preferred due to ease of manufacturing and increased surface area. The high cell densities (e.g., as high as about 600, about 800, and even about 1,200 or higher cells per square inch) and low cell wall thicknesses (e.g., less than or equal to about 4.3 mils(about 0.109 mm) about 2.5 mils(about 0.064 mm) preferred) can result in relatively fragile treatment elements with isostatic crush strengths of less than or equal to about 150 pounds per square inch (psi), or even less than or equal to about 100 psi. Other substrate media such as foams, diesel catalysts and diesel particulate filters can also have isostatic crush strengths of less than or equal to about 150 psi, or even less than or equal to about 100 psi.

In the embodiment where the exhaust emission control device 110 is a diesel particulate trap, the treatment element 114 can be a permeable substrate, e.g., silicon carbide, and the like. The treatment element typically has a cellular or honeycomb structure that includes a plurality of cells or passages for the exhaust gas and increase the surface area of the treatment element. In diesel particulate traps, alternate cells on the inlet and outlet ends are preferably plugged to ensure that the exhaust gas passes through the walls of the element.

In an exhaust emission control device 110, a catalyst is typically disposed on and/or throughout the treatment element 114 for converting exhaust gasses to acceptable emissions levels. The catalyst is capable of reducing the concentration of at least one component in the gas. The catalyst may comprise one or more catalyst materials that are wash coated, imbibed, impregnated, physisorbed, chemisorbed, precipitated, or otherwise applied to the substrate. Possible catalyst materials include metals, such as platinum, palladium, rhodium, iridium, osmium, ruthenium, tantalum, zirconium, yttrium, cerium, nickel, copper, and the like, as well as oxides, alloys, and combinations comprising at least one of the foregoing catalyst materials, and other catalysts.

The catalyst material may be combined with additional materials, or sequentially disposed on the substrate with additional materials. The additional materials may comprise oxides (e.g., alumina, zirconia, titania, and the like), aluminides, hexaaluminates, and the like, and combinations comprising at least one of the foregoing materials. Where an aluminide is used, preferably the aluminide comprises an aluminum in combination with at least one additional metal, such as, nickel, iron, titanium, copper, barium, strontium, calcium, silver, gold, platinum, and oxides, alloys, and combinations comprising at least one of the foregoing metals, with nickel, iron, titanium, and oxides, alloys, and combinations comprising at least one of the foregoing metals particularly preferred. Where a hexaaluminate is employed, the hexaaluminate preferably comprises a crystalline structure of aluminum and oxygen.

The additional materials may further comprise stabilizing agents, such as, Group II metals, rare earth metals, Group VIII metals, and the like, as well as, oxides, alloys, and combinations comprising at least one of the foregoing agents. Preferred stabilizing agents include barium, platinum, palladium, osmium, strontium, lanthanum, ruthenium, iridium, praseodymium, rhodium, gold, manganese, cobalt, and the like, as well as, oxides, alloys, and combinations comprising at least one of the foregoing agents, with barium, lanthanum, and combinations comprising at least one of the foregoing agents particularly preferred.

A support element 115 is disposed e.g., concentrically, around the treatment element 114. The support element 115 insulates the shell from both high exhaust gas temperatures and the exothermic catalytic reaction occurring within the catalyst substrate. The support element 115 further enhances the structural integrity of the treatment element 114 by applying compressive radial forces about it, reducing its axial movement, and retaining it in place.

The support element 115 comprises a plurality of pellets, beads, particles, spheres, fibers, and other geometries, as well as combinations comprising one or more of the foregoing geometries (hereinafter referred to as pellets). The pelletized retention material has a major axis diameter of less than the distance 120 between the treatment element 114 and the shell. The pellets can comprise any geometry, such as, round, spherical, cylindrical, oblong, polygonal, irregular, other shaped particles as well as combinations comprising one or more of the foregoing shapes, or other shaped particles.

The pelletized retention material can be formed from a sheet or mat by cutting, shredding, or otherwise forming smaller pieces. The pelletized retention material can also be formed by extruding, curing, and pelletizing the retention materials. The end result is that the pelletized retention material is flowable, that is, can be poured, flowed or dispensed in the space between the treatment element and the shell.

The retention material can either be an intumescent material (e.g., a material that comprises vermiculite component, i.e., a component that expands upon the application of heat), a non-intumescent material, or a combination thereof. The retention materials can comprise ceramic materials, e.g., ceramic fibers, and other materials such as organic and inorganic binders and the like, or combinations comprising at least one of the foregoing materials. Non-intumescent materials include materials such as those sold under the trademarks “NEXTEL” and “INTERAM 1101 HT” by the “3M” Company, Minneapolis, Minn., or those sold under the trademark, “FIBERFRAX” and “CC-MAX” by the Unifrax Co., Niagara Falls, N. Y., and the like. Intumescent materials include materials sold under the trademark “INTERAM” by the “3M” Company, Minneapolis, Minn., as well as those intumescent materials which are also sold under the aforementioned “FIBERFRAX” trademark, as well as combinations thereof and others.

The retention material can comprise ceramic fibers, vermiculite and binders. For example, the retention materials can comprise up to about 90 wt % ceramic fibers, about 10 wt % to about 60 wt % of vermiculite, and about 0.1 wt % to about 20 wt % a binder, based upon the total weight of the retention material. In one embodiment, the retention material comprises about 5 wt % to about 90 wt % ceramic material (e.g., pellets, fibers, and/or the like), with less than or equal to about 85 wt % ceramic material preferred. Also preferred is an amount of vermiculite of greater than or equal to about 25 wt %, with greater than or equal to about 35 wt % more preferred, based upon the total weight of the retention material.

The choice of intumescent materials can vary depending on the desired end use. For example, for higher temperatures, that is, above about 500° C., unexpanded vermiculite materials are suitable since they start to expand at a temperature of about 300° C. to about 340° C. to fill the space between the treatment element and the shell. For lower temperature use, that is, temperatures below about 500° C., such as in diesel particulate filters, expandable graphite and unexpanded vermiculite materials may conveniently be used as graphite starts to expand at about 210° C. Treated vermiculites are also useful and expand at a temperature of about 290° C.

Suitable organic binder materials for the retention material include aqueous polymer emulsions, solvent based polymer solutions, polymers, polymer resins (i.e., 100 percent solids), and the like. Aqueous polymer emulsions are organic binder polymers and elastomers in the latex form, for example, natural rubber lattices, styrene-butadiene lattices, butadiene-acrylonitrile lattices, ethylene vinyl acrylate lattices, lattices of acrylate and methacrylate polymers and copolymers, and the like. Polymers and polymer resins include natural rubber, styrene-butadiene rubber, other elastomeric polymer resins. Acrylic latex and polyvinyl acetate organic binders are also suitable.

In the method disclosed herein, the pelletized retention material is dispensed into the space 120 between the treatment element 114 and the shell 112 (FIG. 1). The space 120 can vary between the type and design of the device, e.g. a catalytic converter or a diesel particulate filter. The space 120 is of a size such that is sufficient to provide thermal insulation, to overcome differences in thermal expansion between the element and the shell and to balance the dimensional differences between the catalyst and the shell during both assembly and operation. The space 120 can be about 2 millimeters (mm) to about 20 mm or so, depending upon the overall size of the exhaust emission control device. Preferably the space 120 is about 4 mm to about 8 mm. The space 120 may be of a substantially uniform size along the length of the treatment element 114/shell 112 assembly, may have varying sizes along the length, and/or may be smaller at the ends than at the center to retain the pelletized mat support.

The exhaust emission control device 110 can be assembled in several different ways. In one method, a barrier 119 is used to retain the pelletized retention material between the treatment element and the shell. The barrier 119 can be any material which is capable of retaining the pelletized retention material between the treatment element and the shell and that can also withstand the operating temperatures of a motor vehicle emission control device. The barrier can be in the shape of, for example, a rope, a screen, a braided structure, a foil, fibers, wires, other shapes, as well as combinations comprising one or more of the foregoing shapes. The material of the barrier can be, for example, steel, ceramic, other materials, as well as combinations comprising one of more of the foregoing materials. A preferred barrier is a stainless steel wire rope pellet retention member. The barrier may be fastened or secured onto the treatment element 14 with tape or adhesive or by mechanical means such as stapling, staking, crimping, welding, bonding, or combinations comprising one or more of the foregoing fastening methods. Alternatively, the barrier may be held in place by pressure or other non-external means.

The barrier may be of a size and shape suitable to maintain the pelletized retention material within the space 120 between the treatment element 114 and the shell 112. The barrier 119 has a diameter of a size such that the difference between the space 120 and the diameter of the barrier is no more than the minor axis diameter of the pelletized retention material. In other words, the barrier 119 has a diameter sufficient to retain the pelletized retention material within the space 120.

In another assembly method an end cone, end plate or manifold 122 is attached to or formed at a first end 124 of shell 112. A treatment element 114 is then disposed inside shell 112 such that space 120, if any, between treatment element 114 and shell 112 at the first end 124 is of a size to retain the pelletized retention material (FIG. 3). A pelletized retention material is then disposed in space 120 between treatment element 114 and shell 112 to form a support element 115. The second end 126 of shell 112 is then formed by attaching, (e.g., by welding) or forming (e.g., spinforming) an end cone, end plate or manifold such that the support element 115 is retained between treatment element 114 and shell 112. In this embodiment, no barriers are required to retain the pelletized retention material between the shell and the treatment element. An exhaust emission control device assembled by this method is illustrated in FIG. 4.

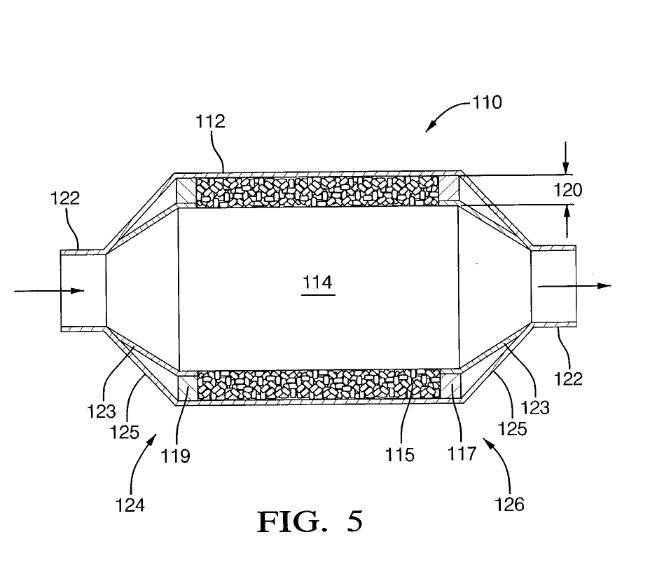

In another method, a double end cone structure is used (FIG. 5). An inner end cone 123 may be fitted around an end of treatment element 114 and an outer end cone 125 may be attached to the shell 112. Treatment element 114 with the inner end cone 123 is then disposed within the shell 112 containing the outer end cone 125 such that the inner end cone 123 is within the outer end cone. An optional barrier 119 may be placed in the space 120 between treatment element 114 and shell 112. The pelletized retention material is then dispensed in the space 120 between the treatment element 114 and the shell 112 to form support element 115. The second end 126 is then closed by any standard method.

### EXAMPLES

A cordierite honeycomb treatment element with about 900 cells per square inch can be wash coated with a catalyst comprising about 30 grams per cubic foot (1,067 grams per cubic meter g/m³) to about 50 grams per cubic foot g/ft³ (1,780 grams per cubic meter) platinum and about 100 grams per cubic foot (3,560 grams per cubic meter) to about 300 grams per cubic foot (10,680 grams per cubic meter) palladium. The coated treatment element can then be disposed within a stainless steel shell having an endcone at one end, such that the space between the treatment element and the shell is about 8 mm. A stainless steel wire rope can be disposed between the shell and the treatment element at the end with the endcone to hold the retention material between the treatment element and the shell. Pelletized retention material comprising about 45 wt % to about 65 wt % vermiculite, and about 30 wt % to about 45 wt % refractory ceramic fibers (based upon the total weight of the retention material) can be cut into pieces having a 2 mm minor axis and an about 2 to about 8 mm major axis. The retention material can then be poured into the space between the treatment element and the shell. Once the space from the wire rope to the opposite end of the treatment element has been filled with the retention material, a second wire rope can be disposed around the periphery of the treatment element to retain the retention material in place. The open end of the shell can then be closed by spinforming an endcone on the second end of the shell or by attaching a preformed endcone, endplate, manifold, or the like. The assembled catalytic converter can then be heated to a temperature of about 500° C. to expand the mat.

The method of making an exhaust emission control device disclosed herein minimizes the pressure imposed on the treatment element during assembly. The pellets of the retention element may move so that the forces exerted by an expanding intumescent support element may more easily be substantially distributed. The use of a pelletized support element eliminates the step of wrapping the support element around the treatment element, thus resulting in substantially less breakage of the treatment element. The pelletized retention material can be an intumescent material that expands upon heating to substantially completely fill the gap between the treatment element and the shell. The pelletized retention material fixes the treatment element in place which reduces vibration and other movement of the treatment element. This improved method has the advantages of less waste of treatment elements due to less breakage and also simplified assembly due to elimination of the step of wrapping a support mat around the treatment element.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method of making an exhaust emission control device, comprising:
disposing a treatment element within a shell;
dispensing a pelletized retention material between the shell and the treatment element; and
securing the pelletized retention material between the shell and the treatment element.

2. The method of claim 1, further comprising disposing a first barrier between the treatment element and the shell prior to dispensing the pelletized retention material.

3. The method of claim 2, further comprising disposing a second barrier between the treatment element and the shell after dispensing the pelletized retention material.

4. The method of claim 1, further comprising disposing a catalyst on the treatment element.

5. The method of claim 1, further comprising attaching a first end cone to a first end of the shell prior to disposing the treatment element within the shell, wherein the first end cone secures the pelletized retention material within the shell.

6. The method of claim 5, further comprising attaching a second end cone to the opposite end of the shell from the first end cone after dispensing the pelletized retention material.

7. The method of claim 1, wherein the treatment element has an isostatic crush strength of less than or equal to about 150 psi.

8. The method of claim 1, wherein the treatment element has an isostatic crush strength of less than or equal to about 100 psi.

9. The method of claim 1, wherein the retention material comprises about 5 wt % to about 90 wt % of a ceramic material and about 10 wt % to about 60 wt % vermiculite, based upon the total weight of the retention material.

10. The method of claim 1, wherein the retention material has a geometry selected from the group consisting of pellets, beads, particles, spheres, fibers, and combinations comprising one or more of the foregoing geometries.

11. An exhaust emission control device formed by the method of claim 1.

12. An exhaust emission control device, comprising:
a shell;
a treatment element disposed within the shell; and
a pelletized retention material disposed between the treatment element and the shell.

13. The exhaust emission control device of claim 12, further comprising at least one barrier disposed between the treatment element and the shell.

14. The exhaust emission control device of claim 12, wherein the retention material comprises about 5 wt % to about 90 wt % of a ceramic material and about 10 wt % to about 60 wt % vermiculite, based upon the total weight of the retention material.

15. The exhaust emission control device of claim 12, wherein the retention material has a geometry selected from the group consisting of pellets, beads, particles, spheres, fibers, and combinations comprising one or more of the foregoing geometries.

16. An exhaust emission control device, comprising:
a shell;
a treatment element disposed within the shell, wherein the treatment device comprises a catalyst; and
a pelletized retention material disposed between the treatment element and the shell, wherein the retention material comprises vermiculite and has a geometry selected from the group consisting of pellets, beads, particles, spheres, fibers, and combinations comprising one or more of the foregoing geometries.
